(19) United States
(12) Patent Application Publication
(10) Pub. No.: US 2003/0074409 A1
(43) Pub. Date: Apr. 17, 2003

(54) Method and apparatus for generating a user interest profile

(75) Inventor: Richard M. Bentley, Cambridge (GB)

Correspondence Address: OLIFF & BERRIDGE, PLC., P.O. BOX 19928, ALEXANDRIA, VA, 22320, US

(73) Assignee: XEROX CORPORATION, Stamford, CT

(21) Appl. No.: 09/977,303

(22) Filed: Oct. 16, 2001

(51) Int. Cl. G06F 15/173; G06F 15/16

(52) U.S. Cl. 709/206; 709/224

(57) ABSTRACT

A method of generating a user interest profile is described. The method comprises monitoring electronic messages directed to the user. Electronic messages which satisfy at least one predetermined condition indicating that they are likely to include information relevant to the user's interests are selected. Profile data is then extracted from those selected messages.

### BACKGROUND OF THE INVENTION

1. Field of the Invention

The invention relates to a method of generating a user interest profile.

2. Description of Related Art

The rapid growth in email traffic, Web sites, on-line databases and so on has greatly increased the amount of information available to on-line individuals. As a result, the task of locating relevant information is becoming harder and more time-consuming. The emergence of so-called “Recommender systems” is one trend in this area, intended to facilitate the filtering of information to identify items of interest. Recommender systems pro-actively locate such items on the user's behalf, then “recommend” these items for the user's attention. These systems, such as the Xerox “Knowledge Pump” (see for example, “Knowledge Pump: Supporting the Flow and Use of Knowledge”, by Glance et al., in: Springer Verlag, Borghoff, U. and Pareschi, R. (Eds), Information Technology for Knowledge Management, 1998), use representations of user “interests” to determine the relevance of information items (often documents) to each user. They might continually scan for new material, or execute only when new items are added to a repository. If an item “matches” (part of) a user's interest representation, the user is notified in some way and might be sent the item (or a link to the item) automatically.

The idea of registered “interests” is not unique to document-based recommender systems; event-based notification services like the University of Queensland's “Elvin” (described on the Internet at http://elvin.dstc.edu.au/intro/overview.html), and the Xerox “Yaka” system (see for example, “Yaka: Document Notification and Delivery Across Heterogeneous Document Repositories”, by Arregui et al., in: Proceedings of CRIWG 2001, Darmstadt, Germany, Sep. 6-8, 2001), also use the notion of user interests to filter the propagation of events. A characteristic of these and similar systems is that users are required to indicate their interests to the system. This might be done explicitly—for example, asking users to complete a form with checkboxes for the type of events to notify the user of, or the keywords the system should look out for in new documents—or implicitly—e.g. monitoring the Web pages users' visit most often and using text analysis to extract keywords from these pages to form an ‘interest’ filter (as described for example in European Patent Application EP 1 050 832 A2).

U.S. Pat. No. 5,724,567 to Rose et al describes the general approach of using user interest profiles to filter documents for relevance. The Patent describes a number of methods of refining interest profiles based on user feedback on the relevance of previous recommendations. This “adaptive” approach employs statistical Information Retrieval techniques to “weight” different keyword terms, based on a user's interest profile, and then “score” each document for its degree of relevance. Variations on this approach, and possible realizations of it, are described in the Patent. The accompanying text to the Patent states that an advantage of the Patented invention is that “Originators of messages do not have to be concerned with who will find a particular message to be of interest”—implying that messages should be sent with no specific recipient, and the system will determine recipients based on their interest profiles.

Early work such as Information Lens, Malone, T., Grant, K., Turbak, R., Brobst, S. and Cohen, M. (1987): Intelligent information-sharing systems, in Communications of the ACM, 30, 1987, pp 484-497 allowed users to define rules to automate the processing of incoming email, such as which email folder to store the mail in, how the user should be notified of its arrival etc. These ideas can now be found in more modern email clients like Microsoft Outlook® (and especially motivated by the need to filter “junk email” or “Spam”, where the emphasis is on automatically deleting messages from specific senders, contain specific keywords etc.). Although flexible, in that users can instruct their mail client to look for specific words in the subject or content of the message, these approaches: a) do not address the extraction of “interest profiles” from the content of the email messages and b) do rely on the recipients to explicitly set up and maintain the rules.

Of interest is the Beehive work by Bernardo Huberman and Michael Kaminsky at Xerox (published as “Beehive: A system for cooperative filtering and sharing of information”, Technical report, Dynamics of Computation Group, Xerox Palo Alto Research Center, August 1996), which concerns the analysis of an individual's email to determine who that individual is interacting with and how strongly (based on frequency of email exchange). This information is used to define “communities” of like-minded individuals for the purposes of shared recommendation; a user can then send a document to a particular community, and the system will forward the document to the individuals who are members of that community by consequence of their patterns of email interaction.

### SUMMARY OF THE INVENTION

In accordance with the invention, there is provided a method, and apparatus therefor, for generating or extending a user interest profile. The method comprises monitoring electronic messages directed to the user, selecting those electronic messages satisfying at least one predetermined condition indicating that they are likely to include information relevant to the user's interests, and extracting profile data from the selected messages.

The invention is based on the understanding that knowledge of an individual's interests is often communicated to others through routine working activities, such as in meetings. This communication need not be explicit, and in fact might be quite subtle. The key observation is that individuals often use their knowledge of others' interests, projects, roles, skills and more to target items of relevance to others. As information is increasingly first accessed in electronic form (from Web sites, mailing lists etc.), the mechanism often employed for this “targeted distribution” is email “forwarding”. (NB. this does not necessarily mean the information being forwarded is email—it might be a Web page for example—but that email is often used as the medium for forwarding the information to the interested user.)

In accordance with one aspect of the invention, an individual's “interest profile” is defined or extended by analyzing the information which others forward to them by email. This would allow a system to obtain more information on users' interests, without the need to represent details of the roles, projects and so on that each user is involved with. Modeling such details and then deriving mappings to particular items of interest is not trivial in any case, and a strength of this method is that it takes advantage of the work that other people already do outside the system in making decisions that items of information may be “of interest” to others (i.e. in making the mapping from users' activities to the “relevance” of an item of information).

In accordance with another aspect of the invention, email messages that are received are selectively analyzed to derive interest information, rather than treating every email as “raw material” for processing. Once selected, existing techniques for extracting interest profile information might be applied.

Yenta, a ‘matchmaking’ system under development at the MIT Media Lab (http://foner.www.media.mit.edu/people/foner/yenta-brief.html), does look at the content of email messages to build profiles (as well as users' files, newsgroup posts etc.) but examines all the users' received email messages rather than only those which result from “targeted forwarding”. The ‘Beehive’ product from Abuzz selects email messages for processing, but the intent here is to build up “skills profiles” for future targeting of questions directly to organizational experts. Beehive looks specifically at emails which are responses to questions previously emailed to the system itself.

The predetermined condition can take a variety of forms and typically will include one or more of determining an electronic message which has an attachment, a message which constitutes a forwarded message, and a message containing a URL.

All these types of message imply that others have targeted the message for the user.

The information which is extracted may be obtained from a message added to a forwarded message (on the basis that the forwarder may have neatly summarized the content of the forwarded message), the body of an attachment, or data from the subject text of the message.

In some cases, all data extracted will be stored to define or add to the profile. In other cases, the user may be prompted with the extracted data to indicate whether or not he wishes that data to be stored.

In yet a further approach, the extracted data could be used immediately to search a repository such as the Internet for relevant information which is then presented to the user when he opens the electronic message concerned.

### BRIEF DESCRIPTION OF THE DRAWINGS

Some examples of methods according to the invention will now be described with reference to the accompanying drawings, in which:

FIG. 1 is a flow diagram illustrating a first example;

FIG. 2 illustrates an example of a forwarded email message;

FIGS. 3 and 4 are flow diagrams similar to FIG. 1 but illustrating two further methods; and

FIG. 5 illustrates another example of a forwarded email message.

### DETAILED DESCRIPTION

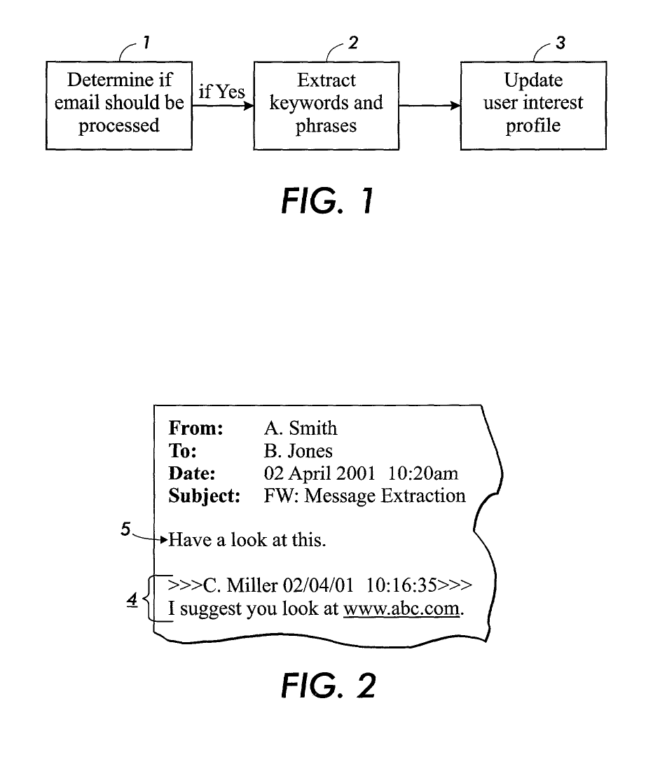

FIG. 1 illustrates the basic components of a method according to the invention. These steps 1-3 are summarized below.

1. Determine if email should be processed: Not every email message a user receives will be the result of information forwarding—this component determines if the email message is relevant for processing as such. This is one of the invention's key elements of novelty.

2. Extract keywords and phrases: This component processes email messages selected in Stage 1 to extract keywords and/or phrases which might be used to specify “interest patterns” or “query terms”, used for matching against other documents.

3. Update user interest profile: This component adds the extracted interest patterns to the set of interests for this user. Note that there is some flexibility when (and if) this stage occurs, and whether this is done automatically or with user input.

The novelty in this process lies in stage 1 which acts to select those emails which are to be processed.

A number of methods are possible to determine which emails a user receives are the result of targeted information distribution. One method is to select only those email messages which contain “attachments”—information linked to the email in the form of separate documents. Alternatively, or additionally, the system can take advantage of one or all of the following to detect an email message that contains forwarded information:

If the original information being forwarded was itself an email, the subject line of the received email message will start with a characteristic symbol such as “FW:” or a non-English equivalent, and/or contain standard strings of characters in the body of the mail message;

Messages which contain URLs are often sent as pointers to related information;

Web pages sent using Internet Explorer's “Send page by email” function have a subject line which ends in “.html”.

Of course it will be appreciated by those skilled in the art that there are many other ways in which relevant emails could be identified.

FIG. 2 illustrates an example of a forwarded message. In this example, an initial email was sent from C. Miller to A. Smith as shown at 4, the text referring to a web address and the subject in the subject line being “Message Extraction”. The recipient (A. Smith) considered the information to be of interest to B. Jones and thus forwarded the message to him, adding his own comment 5. The appearance of the forwarded message is shown in FIG. 2 where it will be seen that the subject line has the descriptor “FW”.

Once selected, the mail message would be processed to extract keywords or phrases that might serve as ‘query terms’ for the purposes of defining an interest pattern (Stage 2). This may occur immediately following Stage 1, though this need not be the case; messages might be “batched” for processing as a group, for example. Numerous techniques exist for information indexing and keyword/phrase extraction, ensuring ‘noise’ terms are not selected as keywords and frequently occurring terms are assigned more weighting. To be useful in this context, this Stage 2 would especially have to process any attachments to the email message, requiring functionality to comprehend the different data types such attachments may have. Modern text-indexing and retrieval packages (such as Verity—see on the Internet www.verity.com) have these capabilities. It might also be a requirement for the system to retrieve Web documents from URLs sent in email messages and then process these for relevant interest patterns—a functionality that is standard in modern “Web crawler” packages and index generators like Enfish Tracker Pro (described on the Internet at www.enfish.com).

In the example of FIG. 2, the processor will note the existence of the “FW” descriptor in the subject line and will use this to select the message for further processing. In addition, or alternatively, the processor may note the existence of a URL in the base message.

In another important example, the message 5 added by the forwarder can be reviewed. Such text often acts to contextualize the message, often containing the rationale for the forwarding. As such, it can be easier to extract relevant keywords from the added text (e.g. “I thought you might be interested in this for your work on simulated annealing”) than from the attachment (since there is less text to search, less noise terms, etc.).

Following the extraction of the interest pattern from a targeted mail message, the system automatically updates the user's interest profile (Stage 3), for use in future filtering operations.

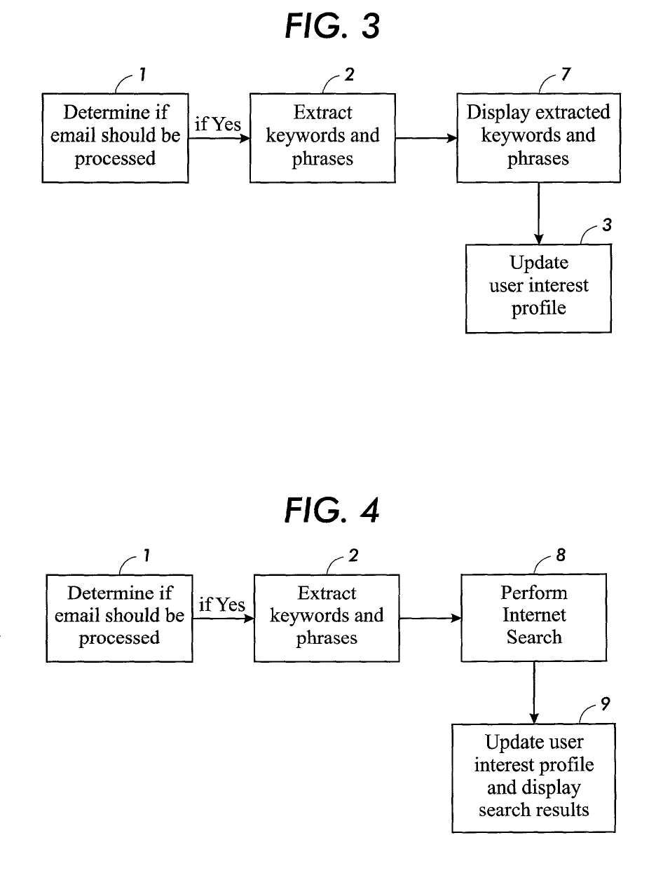

There are a number of alternative possibilities, however. Thus, in FIG. 3, following stage 2, the processor displays the extracted keywords and phrases (Stage 7) to allow the user to indicate using a mouse or the like which of these he wishes to add to his profile. Following this selection, the user interest profile is updated.

In Stage 7, the user could also indicate a level of importance to be assigned to each keyword and phrase.

In a further alternative (FIG. 4), either before or after storing the extracted keywords and phrases, the system could use the extracted keywords and phrases to scan available repositories for documents which match the interest pattern (for example via the Internet) (Stage 8), in order to present the user with a set of links to related information when they open the email message to read it (Stage 9).

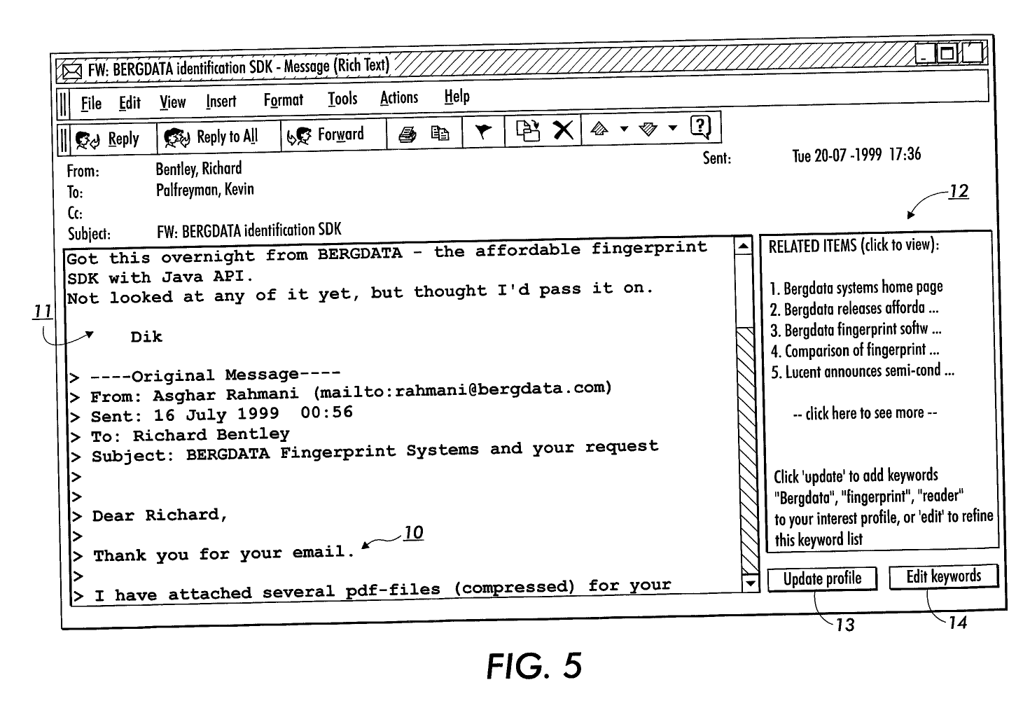

FIG. 5 illustrates another example of a forwarded email message. Part of a received email message, which is indicated by reference numeral 10, was then forwarded with an appended message 11 to a further recipient who the original recipient thought might be interested in the information. When the recipient opened the forwarded message, the system reviewed the appended message 11 to extract useful keyword data which is then presented alongside the message at 12 together with links to other related information which the system has automatically retrieved/searched based on the extracted keywords. As can be seen, the window 12 also provides the recipient with the opportunity to update his keyword profile at 13 and to edit the keywords at 14.

Since the user interest profile is generated following storage, it can subsequently be used in a conventional manner to scan repositories as required by the user. This might be on a regular monthly or daily basis to provide the user with updates in his areas of interest.

As an optional extension, the processing of email containing forwarded information might also be useful in the identification of “experts” and/or “communities” of users. For example, interest profiles might be compared to identify users having centers of interest in a domain, with the user receiving the most forwarded information on the topic being more likely to be the organizational “expert”. Identification of experts and communities of users is an important area in the Knowledge Management field.

It will be appreciated by those skilled in the art that the method for generating or extending a user interest profile described herein can be embodied using software components and hardware components that operate on computer systems such as: a personal computer, a workstation, a mobile/cellular phone, a handheld device etc.

The hardware components include a Central Processing Unit (i.e., CPU), Random Access Memory (RAM), Read Only Memory (ROM), User Input/Output (“I/O”), and network I/O. The User I/O may be coupled to various input and output devices, such as a keyboard, a cursor control device (e.g., pointing stick, mouse, etc.), a display, a floppy disk, a disk drive, an image capture device (e.g., scanner, camera), etc.

RAM is used by CPU as a memory buffer to store data such as profile data. The display is an output device that displays data provided by CPU or other components in a computer system. In one embodiment, display is a raster device. Alternately, the display may be a CRTs or LCD. Furthermore, user I/O may be coupled to a floppy disk and/or a hard disk drive to store data. Other storage devices such as nonvolatile memory (e.g., flash memory), PC-data cards, or the like, can also be used to store data used by computer system. The network I/O provides a communications gateway to a network such as a LAN, WAN, or the Internet. The network I/O is used to send and receive data over a network connected to one or more computer systems or peripheral devices.

The software components include operating system software, application program(s), and any number of elements for generating or extending a user interest profile. The operating system software may represent an MS-DOS, the Macintosh OS, OS/2, WINDOWS®, WINDOWS® NT, Unix operating systems, Palm operating system, or other known operating systems. Application Program(s) may represent one or more application programs such as word processing programs, spreadsheet programs, presentation programs, auto-completion programs, editors for graphics and other types of multimedia such as images, video, audio etc.

The apparatus for generating or extending a user interest profile may be implemented by any one of a plurality of configurations. For example, the processor may in alternative embodiments, be defined by a collection of microprocessors configured for multiprocessing. In yet other embodiments, the functions provided by software components may be distributed across multiple computing devices (such as computers and peripheral devices) acting together as a single processing unit. Furthermore, one or more aspects of software components may be implemented in hardware, rather than software. For other alternative embodiments, the computer system may be implemented by data processing devices other than a general-purpose computer.

Using the foregoing specification, the invention may be implemented as a machine (or system), process (or method), or article of manufacture by using standard programming and/or engineering techniques to produce programming software, firmware, hardware, or any combination thereof.

Any resulting program(s), having computer-readable program code, may be embodied within one or more computer-usable media such as memory devices or transmitting devices, thereby making a computer program product or article of manufacture according to the invention. As such, the terms “article of manufacture” and “computer program product” as used herein are intended to encompass a computer program existent (permanently, temporarily, or transitorily) on any computer-usable medium such as on any memory device or in any transmitting device.

Executing program code directly from one medium, storing program code onto a medium, copying the code from one medium to another medium, transmitting the code using a transmitting device, or other equivalent acts may involve the use of a memory or transmitting device which only embodies program code transitorily as a preliminary or final step in making, using, or selling the invention.

Memory devices include, but are not limited to, fixed (hard) disk drives, floppy disks (or diskettes), optical disks, magnetic tape, semiconductor memories such as RAM, ROM, Proms, etc. Transmitting devices include, but are not limited to, the Internet, intranets, electronic bulletin board and message/note exchanges, telephone/modem based network communication, hard-wired/cabled communication network, cellular communication, radio wave communication, satellite communication, and other stationary or mobile network systems/communication links.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or sub-combination thereof, which embody the invention as set forth in the claims.

The invention has been described with reference to particular embodiments. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

1. A method for generating or extending a user interest profile, comprising:
monitoring electronic messages directed to the user;
selecting those electronic messages satisfying at least one predetermined condition indicating that they are likely to include information relevant to the user's interests; and
extracting profile data from the selected messages.

2. A method according to claim 1, further comprising storing the extracted profile data.

3. A method according to claim 2, further comprising displaying the extracted profile data to the user and storing only those data indicated by the user.

4. A method according to claim 1, wherein the at least one predetermined condition is constituted by the message having an attachment.

5. A method according to claim 1, wherein the at least one predetermined condition is constituted by the message being a forwarded message.

6. A method according to claim 5, wherein said extracting further comprises operating on words added by a forwarder of the forwarded message.

7. A method according to claim 1, wherein the at least one predetermined condition is constituted by the message including a URL.

8. A method according to claim 1, wherein the profile data comprise one or more keywords or phrases.

9. A method according to claim 1, wherein said extracting further comprises operating on data contained within a subject line of the message.

10. A method according to claim 1, wherein said extracting further comprises operating on an attachment to the message.

11. A method according to claim 1, further comprising using the extracted data to search an information repository for matching items.

12. An apparatus for generating or extending a user interest profile, the method comprising:
means for monitoring electronic messages directed to the user;
means for selecting those electronic messages satisfying at least one predetermined condition indicating that they are likely to include information relevant to the user's interests; and
means for extracting profile data from the selected messages.

13. An apparatus according to claim 12, wherein the at least one predetermined condition is constituted by the message having an attachment.

14. An apparatus according to claim 12, wherein the at least one predetermined condition is constituted by the message being a forwarded message.

15. An apparatus according to claim 14, wherein said extracting means operates on words added by a forwarder of the forwarded message.

16. An apparatus according to claim 12, wherein the at least one predetermined condition is constituted by the message including a URL.

17. An apparatus according to claim 12, wherein the profile data comprise one or more keywords or phrases.

18. An apparatus according to claim 12, wherein said extracting means operates on one of data contained within a subject line of the message and an attachment to the message.

19. An apparatus according to claim 12, further comprising:
a display for displaying the extracted profile data to the user; and
a memory for storing only those data indicated by the user.

20. An apparatus according to claim 12, further comprising means for using the extracted data to search an information repository for matching items.
